(19) United States
(12) Patent Application Publication
(10) Pub. No.: US 2016/0200070 A1
(43) Pub. Date: Jul. 14, 2016

(54) COMPOSITE LAMINATES WITH SYNTACTIC CORES

(71) Applicant: TenCate Advanced Composites USA, Inc., Morgan Hill, CA (US)

(72) Inventors: Frank W. Lee, Danville, CA (US); Scott M. Unger, Morgan Hill, CA (US)

(21) Appl. No.: 14/994,794

(22) Filed: Jan. 13, 2016

Related U.S. Application Data
(60) Provisional application No. 62/102,845, filed on Jan. 13, 2015.

(51) Int. Cl. B32B 5/12; B32B 27/00; B32B 3/26

(52) U.S. Cl. CPC B32B 5/12; B32B 3/26; B32B 27/00; B32B 2250/03; B32B 2264/101; B32B 2262/106; B32B 2307/546; B32B 2307/558; B32B 2457/00

(57) ABSTRACT

Described are laminate materials with syntactic cores sandwiched between outer layers. These laminates, which may be very thin, are ideally suited to use in high-stress applications, such as the casings for consumer electronics. The layered structure of an outer layer with a core provides improved strength and durability compared to a single layer material. The addition of a filler, such as microspheres, to the core material allows for adjusting the density, strength, and other material properties of the composite laminate to better suit a particular application.

### CROSS REFERENCE TO RELATED APPLICATIONS

This application claims the benefit of U.S. Provisional Application Ser. No. 62/102,845 (“the '845 application”), filed on Jan. 13, 2015 and entitled “Composite Laminates with Syntactic Core For Consumer Electronics Devices.” The '845 application is hereby incorporated in its entirety by this reference.

### FIELD OF THE INVENTION

Embodiments of the invention relate to composite laminates, and more particularly to composite laminates with syntactic cores.

### BACKGROUND

Many products, such as consumer electronics, require durable, lightweight materials that resist breakage under repeated stress, impact, and flexing. Traditionally, materials like sheet metal or plastics have been used in many of these applications. However, plastic and sheet metal may not be an ideal material solution in all applications because of cost, weight, or a lack of strength and resistance to fatigue.

### SUMMARY

Aspects of the present disclosure relate to composite laminates with an inner syntactic core. A relatively thin composite laminate with a syntactic core sandwiched between two outer layers provides improved strength and impact resistance compared to single layer or multi-layer materials without a core. The syntactic core also provides additional advantages because the characteristics of the core, and the resulting composite laminate, may be adjusted by varying the type and relative amount of the filler material in the syntactic core to adjust strength, density, or other material properties.

### BRIEF DESCRIPTION OF THE DRAWINGS

FIG. 1 is a sectional view of a composite laminate with a syntactic core.

FIG. 2 is a sectional view of a composite laminate with a syntactic core and multi-layered outer layers.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention relate to composite laminates having a syntactic core sandwiched between protective outer layers that impart additional structural integrity to the composite.

The core is “syntactic” in that it is formed of at least two materials that are mixed or otherwise combined to form the core. In one embodiment, the syntactic core includes a thermoset or thermoplastic resin combined with a filler, such as, but not limited to, glass, plastic, or ceramic microspheres (including solid and hollow microspheres), fly ash, fumed silica, aerogel (e.g., a silica-based foam), calcium carbonate, zinc borate, aluminum trihydrate, magnesium hydroxide, barium sulfate, carbon black, metal oxides, bauxite, talc and fiberglass stable fibers. In some embodiments, the filler is selected to reduce the weight of the core. For example, in certain examples, hollow glass microspheres are the selected filler and combined with the resin to impart air bubbles into the core. In certain embodiments, the syntactic core may have a thickness of less than about 1 mm. In some embodiments, the syntactic core may have a thickness of less than about 0.75 mm. In other embodiments, the syntactic core has a thickness of less than about 0.5 mm. The syntactic core can be made in thicknesses starting as low as about 0.02 mm and range in density from about 0.1-0.96 g/cm³ (6-60 lb/ft³).

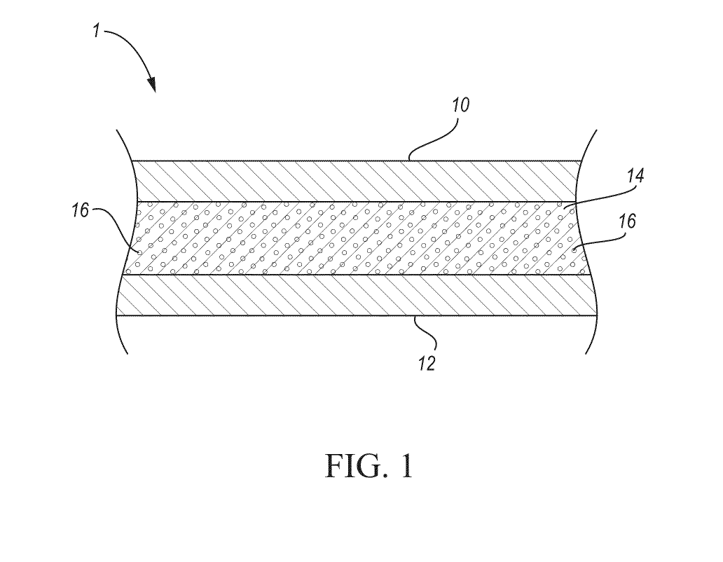

FIG. 1 shows a sectional view of a composite laminate 1. A first outer layer 10 and a second outer layer 12 are positioned on each side of a syntactic core 14 containing at least one filler material 16. The outer layers may 10, 12 be formed from any material having suitable structural integrity to withstand the abuse that will be commonly inflicted upon the composite in a particular application, such as use in the casing of consumer electronics. Suitable outer layer materials include, but are not limited to, fiber reinforced polymeric materials (e.g., reinforced with carbon fibers, glass fibers, aramid fibers, basalt fibers, etc.), glass, metal (e.g., aluminum, titanium), ceramic, plastic, etc. Each outer layer 10, 12 may be of any thickness, including, but not limited to, about 0.025-0.5 mm. The resulting thickness of the composite laminate 1, depending upon the thickness of the outer layers 10, 12 and syntactic core 14, may be from about 0.07 mm to about 2 mm.

In some embodiments, the outer layers 10, 12 are formed of carbon fibers or other reinforcement fibers pre-impregnated with resin (referred to as “prepreg”). The resin may be a thermoset or thermoplastic resin. The carbon fibers within a prepreg sheet may be unidirectional, biaxial, and multi-axial. Prepreg sheets are well known in the art and can be formed using conventional manufacturing methods also well known in the art. One such method is disclosed in U.S. Pat. No. 5,201,979, the entirety of which is incorporated herein by reference.

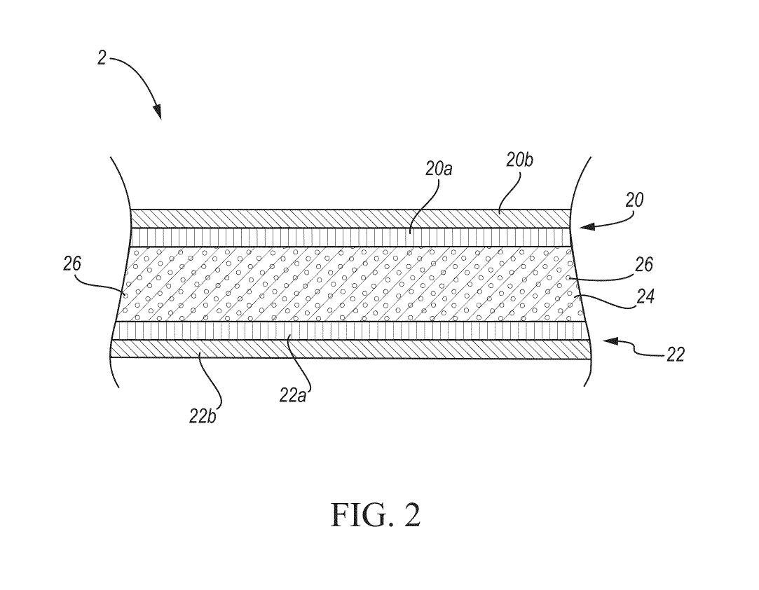

FIG. 2 shows a sectional view of a composite laminate 2 with outer layers 20, 22 on the outside of a syntactic core 24 with at least one filler 26. One or both outer layers 20, 22 may be comprised of multiple layers stacked on either side of the syntactic core 24 and oriented relative to each other and the core 24 in any angular orientation. By way only of example, in one embodiment two prepreg sheets 20a, 20b and 22a, 22b may be stacked on each side of the syntactic core 24 to form the first outer layer 20 and second outer layer 22. The two prepreg sheets 20a, 20b and 22a, 22b on each side of the core 24 may be oriented differently to improve the strength of the composite laminate 2. For example, in one embodiment the fibers of the inner prepreg sheets 20a, 22a most proximate the core 24 are oriented at 90° relative to the fibers of the outer prepreg sheets 20b, 22b. However, the fibers of the prepregs can be provided in any angular orientation and the prepreg sheets stacked in any rotational orientation relative to each other and the core 24. Moreover, any number of layers may be provided in each of the outer layers 20, 22 and different numbers of layers may be provided in each of the outer layers 20, 22 on each side of the core 24. The number of outer layers 20, 22 may be selected depending on the thickness of the individual outer layers 20, 22 and the desired strength of the composite laminate 2.

Referring to FIGS. 1 and 2, the resulting composite laminate 1, 2 may be of any thickness as desired or required for a particular application. In some embodiments, the thickness of the overall composite laminate 1, 2 is between about 0.3 mm-1.5 mm, inclusive.

Composite laminates with a syntactic core may be formed as a planar structure or may be formed (e.g., molded) into any desired shape. The composite laminates may be formed using a variety of methods. For example, if the outer layers 10, 12, 20, 22 are prepregs, the various composite layers may be stacked and heat and pressure applied to fuse the layers together via the resin matrix within the prepregs.

If the outer layers 10, 12, 20, 22 are not pre-impregnated with resin, various methods may be used to laminate the various layers together. In the Resin Transfer Molded (RTM) process, the layers are positioned in a mold and resin is injected into and around the layers in the mold. In the Vacuum-Assisted Resin Transfer Molded (VARTM) process, a vacuum is used to suck low viscosity resin into the mold and through the layers, as opposed to injecting or pumping resin into the mold. Regardless, the resin, once cured, fuses the layers of the composite laminate 1, 2 together.

In Resin Film Infusion (RFI), resin films are interposed between some or all of the composite laminate layers and thermal compression is applied to laminate the layers to each other and form the composite laminate 1, 2.

Embodiments of the composite laminates disclosed herein are extremely stiff and durable despite having a thin core. In some embodiments, the composite laminate 1, 2 has a density between about 0.16-0.99 g/cm³ (10-60 lb/ft³). The stiffness of the composite laminates can be tested using deflection testing pursuant to ASTM D 790, ASTM C 393, or by a simple deflection test wherein a specific load is placed upon laminates of a given thickness and the deflection of the laminate is measure in inches or mm.

Any of the above described components, parts, or embodiments may take on a range of shapes, sizes, or materials as necessary for a particular application of the described invention. The components, parts, or mechanisms of the described invention may be made of any materials selected for the suitability in use, cost, or ease of manufacturing.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A composite laminate comprising:
an inner core comprising a resin and a filler;
a first outer layer; and
a second outer layer,
wherein the inner core is disposed between the first outer layer and the second outer layer, the first outer layer has a thickness of about 0.025 mm to about 0.5 mm, the second outer layer has a thickness of about 0.025 to about 0.5 mm, and the inner core has a thickness of about 0.02 mm to about 1 mm, and the composite laminate has a thickness of about 0.07 mm to about 2 mm.

2. The composite laminate of claim 1, wherein the composite laminate has a thickness of about 0.3 mm to about 1.5 mm.

3. The composite laminate of claim 1, wherein the inner core has a density of about 0.1 g/cm³ and about 0.96 g/cm³.

4. The composite laminate of claim 1, wherein the composite laminate has an overall density of about 0.16 g/cm³ and about 0.99 g/cm³.

5. The composite laminate of claim 1, wherein each of the first outer layer and the second outer layer comprises at least one sheet comprising a plurality of fibers and a polymer.

6. The composite laminate of claim 5, wherein the fibers comprise at least one of carbon fibers, glass fibers, and aramid fibers.

7. The composite laminate of claim 1, wherein the filler comprises microspheres.

8. The composite laminate of claim 7, wherein the microspheres comprise at least one of glass, plastic, and ceramic microspheres.

9. The composite laminate of claim 1, wherein the inner core has a thickness of less than about 0.75 mm.

10. The composite laminate of claim 5, wherein the first outer layer and the second outer layer each comprises a plurality of sheets of fibers reinforced with a polymer.

11. The composite laminate of claim 10, wherein at least one of the plurality of sheets of the first outer layer comprises fibers oriented at an angle relative to fibers of another of the plurality of sheets of the first outer layer.

12. The composite laminate of claim 11, wherein the angle is approximately 90 degrees.

13. The composite laminate of claim 11, wherein at least one of the plurality of sheets of the second outer layer comprises fibers oriented at an angle relative to fibers of another of the plurality of sheets of the second outer layer.

14. A composite laminate comprising:
an inner core comprising a resin and a filler of microspheres;
a first outer layer comprising at least one sheet comprising a plurality of fibers and a polymer; and
a second outer layer comprising at least one sheet comprising a plurality of fibers and a polymer,
wherein the inner core is disposed between the first outer layer and the second outer layer, the first outer layer has a thickness of about 0.025 mm to about 0.5 mm, the second outer layer has a thickness of about 0.025 mm to about 0.5 mm, and the inner core has a thickness of less than about 1 mm, and the composite laminate has a thickness of about 0.07 mm to about 2 mm.

15. The composite laminate of claim 14, wherein the first outer layer and the second outer layer each comprises a plurality of sheets comprising a plurality of fibers and a polymer.

16. The composite laminate of claim 15, wherein at least one of the plurality of sheets of the first outer layer comprises fibers oriented at an angle relative to fibers of another of the plurality of sheets of the first outer layer.

17. The composite laminate of claim 16, wherein the angle is approximately 90 degrees.

18. The composite laminate of claim 15, wherein at least one of the plurality of sheets of the second outer layer comprises fibers oriented at an angle relative to fibers of another of the plurality of sheets of the second outer layer.

19. The composite laminate of claim 18, wherein the angle is approximately 90 degrees.
